(19) United States
(12) Patent Application Publication
(10) Pub. No.: US 2002/0076073 A1
(43) Pub. Date: Jun. 20, 2002

(54) Automatically switched hearing aid communications earpiece

(76) Inventors: Jon C. Taenzer, Los Altos, CA (US); Steven H. Puthuff, Saratoga, CA (US); David Q. Dobras, San Francisco, CA (US)

Correspondence Address: David G. Beck, McCUTCHEN, DOYLE, BROWN & ENERSEN, LLP, Three Embarcadero Center, San Francisco, CA, 94111, US

(21) Appl. No.: 09/739,242

(22) Filed: Dec. 19, 2000

(51) Int. Cl. H04R 25/00

(52) U.S. Cl. 381/315; 381/316

(57) ABSTRACT

The present invention is directed to a hearing aid apparatus which can function in a hearing aid state and a communications state, by automatically switching between the hearing aid state and the communications state. Exemplary embodiments combine the functions of headset operation and hearing aid operation into an apparatus which can connect with communication devices and which can automatically reconfigure itself to function as a hearing aid for addressing a hearing impairment of the user. Exemplary embodiments can be configured small and comfortable to permit wear over extended periods of time.

### BACKGROUND OF THE INVENTION

1. Field of the Invention

The present invention relates generally to hearing aid devices, and more particularly, to hearing aid devices which can alternately function as two-way communication devices.

2. Background Information

Hearing aid devices are well known, and are used to improve the quality of an individual's hearing by amplifying portions of sound that are particular to the individual's hearing impairment. Known hearing aids typically include a sound pick-up device, such as a microphone, located in a vicinity of the individual's ear, some processing circuitry for modifying the sound, and an output device such as a speaker for providing the modified sound to the ear canal of the individual. An exemplary hearing aid device is described in U.S. Pat. No. 4,396,806, entitled “Hearing Aid Amplifier”. This patent describes a programmable hearing aid amplifier having a multiple band amplification with controllable gain and compression signal processing characteristics. The processed signal is fed to a power amplifier to drive a hearing aid transducer, such as a speaker. The hearing aid amplifier includes various bandpass restricted channels for individually shaping the gain, attack and decay characteristics of the selected channel. Signals are supplied to the channels via a high pass filter connected to a microphone input.

Although devices as described in U.S. Pat. No. 4,396,806 are typically used exclusively for addressing hearing impairments, it is also known to use similar devices as communication devices for unimpaired users as well. For example, communication devices are known which use headsets for conveying sound from any of a variety of sources including, but not limited to, telephone networks, portable radios or CD players, or from any other sound transmitting system such that sound can be delivered with relatively high quality to the ear of the user without disturbing others in a vicinity of the user. Such systems have also found widespread use in communication devices used by police, firefighters, secret service agents and the like to receive sound transmissions from remote locations and to transmit sound to the remote locations.

In some cases, the capabilities of a hearing aid device and a two-way communication device have been combined. For example, U.S. Pat. No. 5,721,783 entitled “Hearing Aid With Wireless Remote Processor” describes a hearing aid device which can communicate with, for example, a cellular telephone system or other source of information. As described therein, an ear piece headset interacts with a remote processing unit to process ambient sound in a manner which addresses the hearing impairment of the user. The remote processing unit can include, as an optional feature, a telephone transceiver for communication with a secondary wireless link. However, in such an embodiment, the transceiver unit includes push buttons and controls which the user must activate to communicate via the secondary wireless link.

In addition, conventional communication headsets cannot function effectively with hearing aids. That is, individuals with hearing impairments cannot easily function in jobs requiring headset use, or cannot use headsets to improve communication with secondary sources. Further, hearing aids do not allow bidirectional communication signals to be sent between the hearing aid and communication devices such that the hearing impaired can have the signal processing associated with their hearing enhancement exploited during the use of the communication devices.

Accordingly, there is a need for a hearing aid device which can function as a communication earpiece for bidirectional communication with a remote source, and which can switch between a hearing aid mode, when not in use as a communication device, and a communications mode for bidirectional communication with secondary sources.

### SUMMARY OF THE INVENTION

The present invention is directed to a hearing aid apparatus which can function in a hearing aid mode wherein the apparatus can automatically and alternately switch between a hearing aid state and a communications state, or be used in a communications mode wherein the apparatus can automatically and alternately switch between a communications state and a sleep state. Exemplary embodiments combine the functions of headset operation and hearing aid operation into an apparatus which can connect with communication devices and which can automatically reconfigure itself to function as a hearing aid for addressing a hearing impairment of the user. Exemplary embodiments can be made small and comfortable to permit wear over extended periods of time.

Generally speaking, exemplary embodiments are directed to a hearing aid apparatus comprising a first signal path having a microphone for receiving sound in a vicinity of a user, a processor for processing the sound into processed sound, and a speaker for outputting the processed sound into a vicinity of an ear canal of a user. The apparatus also includes a second signal path for establishing communication between at least a portion of the first signal path and a location remote from the user. A switch is provided for automatically selecting the first signal path or the second signal path in response to detected occurrence of a predetermined condition of the second signal path.

### BRIEF DESCRIPTION OF THE DRAWINGS

The objects and advantages of the present invention will be understood by reading the following detailed description in conjunction with the drawings, wherein:

FIG. 1 shows an exemplary embodiment of a hearing aid apparatus configured for two-way communications in accordance with exemplary embodiments of the present invention; and

FIG. 2 shows an operational state diagram associated with the exemplary FIG. 1 embodiment.

### DETAILED DESCRIPTION OF THE PREFERRED EMBODIMENTS

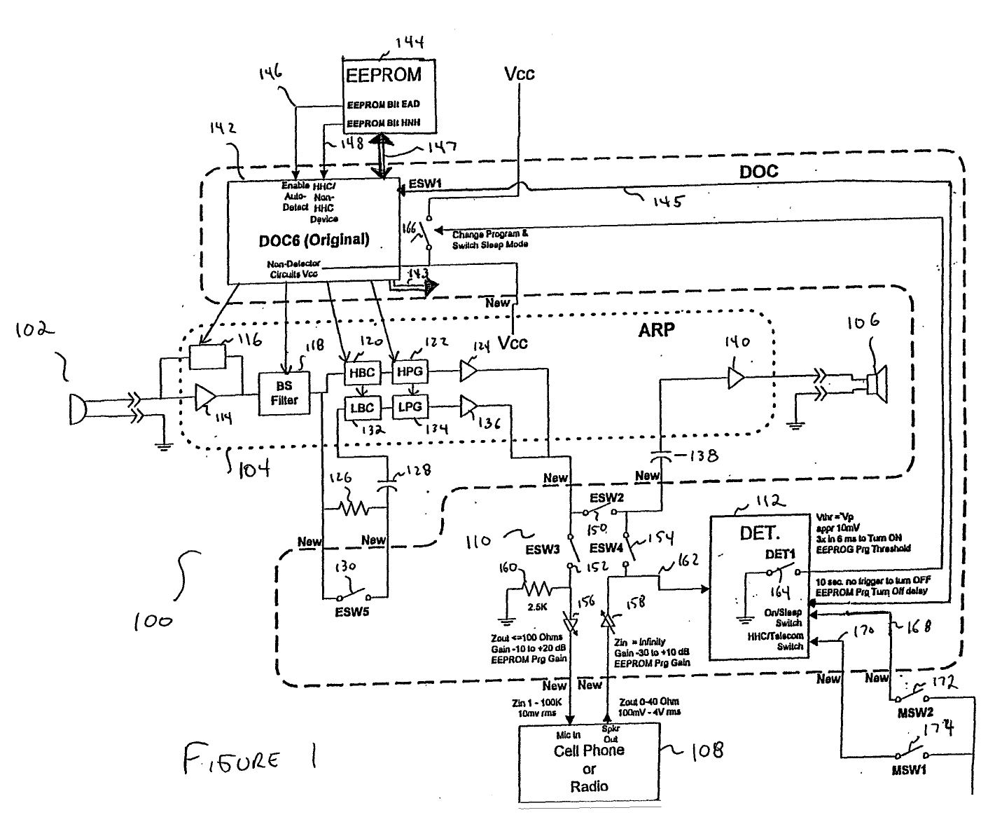

FIG. 1 shows a hearing aid apparatus 100 having a first signal path, associated with a hearing aid state. The first signal path is established between a microphone 102, configured to receive sound in a vicinity of a user, and an output device such as a speaker 106. A processor 104 is provided for processing sound received via the microphone into processed sound. The sound can, for example, be processed to accommodate a hearing impairment of the user. An output of the sound processor is supplied along the first signal path into a vicinity of an ear canal of the user, via use of the speaker 106.

The hearing aid apparatus 100 can alternately establish a second signal path for communication between at least a portion of the first signal path and a location remote from the user. For example, the exemplary FIG. 1 embodiment shows a second signal path which can be established from the microphone 102 to a location remote from the user via a connection to a cell phone or radio 108. Alternately, the signal path can be established from the cell phone or radio 108 back to the hearing aid apparatus for output into a vicinity of an ear canal of the user via the speaker 106.

In accordance with exemplary embodiments, the alternate selection of the first signal path or the second signal path is achieved via inclusion of a switch 110. The switch 110 can selectively close the path between the microphone 102 and the speaker 106 during a hearing aid state, or can alternately establish signal paths between the microphone 102 or speaker 106 and the remote location represented by the cell phone of a telephone network or radio 108, during a communications state.

In accordance with another aspect of the present invention, the switching between the hearing aid state and the communications state can be achieved automatically, in response to a detected occurrence of a predetermined condition of the second signal path. In the exemplary FIG. 1 embodiment, a detector 112 is illustrated for providing an automatic switching between the first signal path of the hearing aid state and the second signal path of the communications state in response to a predetermined condition.

More particularly, switching from the hearing aid state to the communications state can be effected automatically in response to detection of a predetermined condition, such as the detection of a ring signal from the exemplary cell phone 108. As those skilled in the art will appreciate, cell phones include a signal output to indicate a ring condition when a call is being received, and the detector 112 can be used to sense this signal. In response thereto, the detector can initiate a reconfiguration of the switch from the hearing aid state and use of the first signal path, to the communications state and use of the second signal path.

Alternately, automatic switching from the hearing aid state to the communications state can be achieved , in response to a predetermined condition, such as a detection of a user request to initiate a call via cell phone 108. For example, the detector 112 can be used to detect an active telephone line when, for example, the user wishes to place a call. In this case, the detector monitors the speaker output line of the telephone and performs the switching function so as to activate the second signal path and deactivate the first signal path.

The switch from the hearing aid state to the communications state need not only be effected in response to automated detection of a predetermined condition. For example, the switch can also be effected manually via a manually controlled switch 174 that, in the exemplary FIG. 1 embodiment, is associated with the detector 112.

The switching back from the second signal path of the communications state to the first signal path of the hearing aid state can also be effected automatically or manually. For example, automatic switching can be effected using a timeout function such that when the second communications path is inactive for a predetermined time (e.g., ten seconds, or any other set time), the switch 110 automatically returns to the hearing aid state wherein the first signal path between microphone 102 and speaker 106 is activated. Those skilled in the art will appreciate that whenever the second signal path (i.e., the communications state) is active, a low level signal will exist on the line (e.g., tonal signal, background signal or other signal) and can be used as a measurable parameter to determine that the line is active. When the user completes communications over the second signal path, this signal will disappear. After it has disappeared for the predetermined period of time, a switch back to the activation of the first signal path can be effected via switch 110.

Those skilled in the art will appreciate that by providing a timeout feature, occasional drop-out of the low level signal will not result in an immediate switch back to the hearing aid state. The timeout is selected to accommodate the possibility of brief drop-outs of the low level signals, but is not so long as to cause an undesired delay in the switching operation.

Alternately, or in addition to the automatic switching between the hearing aid state and the communications state, the manually controlled switch 174 can be provided to effect a switch between the communications state and the hearing aid state. For example, the user can activate the manually controlled switch 174 to toggle between the hearing aid state and the communications state.

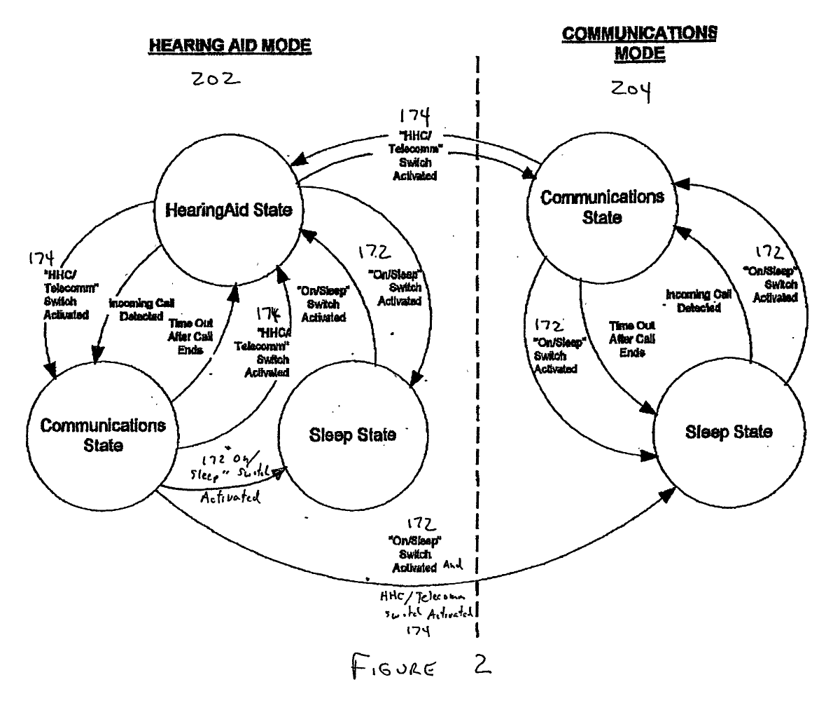

The foregoing automatic and manual switching between a hearing aid state and a communications state is reflected in a hearing mode 202 of the FIG. 2 state diagram.

Although the exemplary FIG. 1 embodiment can be configured to have a single hearing aid mode 202 that can be switched between two states (for example, the hearing aid state and communications state), those skilled in the art will appreciate that any number of states can be employed. For example, in addition to, or in lieu of, the two states described, a sleep state can be provided to conserve power.

Those skilled in the art will also appreciate that any number of operational modes, each having any number of states can be employed. For example, the FIG. 1 switch 174, rather than merely effecting manual switching between two states within a hearing mode, can be used to define different modes of operation, wherein each mode has different operational states. More particularly, as illustrated in the state diagram of FIG. 2, the switches 172 and 174 can be used to not only manually toggle between the hearing aid state and the communications state, but can be used to define two different modes of operation shown in FIG. 2 as a hearing aid (e.g., hearing health care, or HHC) mode 202 and a communications (e.g., telecommunications) mode 204.

A user can select which mode is appropriate for that user, depending upon whether or not the user has a hearing impairment, and from that point forward, generally the apparatus will be used only in the selected mode. Thus, mode selection will be used rarely and primarily to configure the apparatus for a particular user's needs at the time of acquisition. However, should a user subsequently require the opposite mode (for example, if a user develops a hearing impairment during the useful life of the apparatus), the apparatus can, at any time, be switched to the desired mode.

In an exemplary embodiment, to change the hearing aid mode 202 to the communications mode 204, the user first places the apparatus into the communications state associated with the hearing aid mode by momentary activation of push button 174, e.g., as if to initiate a call. Then the user subsequently depresses manual push button 172, which changes the mode and places the apparatus into the sleep state associated with the communications mode. The hearing aid state of the hearing aid mode is the default state for that mode, and the sleep state of the communications mode is the default state for that mode. Thus, in this exemplary embodiment, the apparatus is moved from one mode to the other via the default states.

To change from the communications mode 204 to the hearing aid mode 202, the user first places the apparatus into the communications state associated with the communications mode by momentary activation of push button 172, e.g., as if to initiate a call. Then the user depresses manual push button 174, which changes the mode and places the apparatus into the hearing aid state of the hearing aid mode. The mode and state changing methods are shown in the diagram of FIG. 2.

When the apparatus is placed into the communications mode by a momentary depression of switch 174 followed by a momentary depression of switch 172, the apparatus can automatically alternate between a communications state for communicating via cell phone/radio 108 and a sleep state. However, when the apparatus is placed into the hearing aid mode by a momentary depression of switch 174, the apparatus can automatically alternate between a communications state for communicating via cell phone/radio 108 and a hearing aid state.

Switch 172 can be used to manually effect the sleep state in either mode. When in the sleep state, at least some components of the FIG. 1 apparatus are powered down to conserve battery power. The operational characteristics associated with the automatic awaking of the apparatus from the sleep state will differ depending on whether the apparatus is in the communications mode or the hearing aid mode. However, when manually placed into the sleep state via momentary depression of switch 172, switch 174 has no effect on operation of apparatus 100.

More particularly, when the hearing aid mode is selected via switch 174, the apparatus 100 will automatically switch between the hearing aid state and the communications state (e.g., incoming calls will activate the communications state). The apparatus will not automatically enter the sleep state. However, manual activation of the sleep state via switch 172 will power down components of the apparatus 100 until the sleep state is manually deactivated (see hearing aid mode 202 of FIG. 2).

When the communications mode 204 is selected via the FIG. 1 switches 172 and 174, the hearing aid mode 202 is disabled. When the communications state is inactive, the apparatus will automatically switch to the sleep state. Placement into the sleep state will result in a shutdown of power to various components of the FIG. 1 apparatus (such as the processor 104) until either an incoming signal via cell phone/radio 108 is detected, or an outgoing signal to cell phone/radio 108 is desired. In the communications mode, switch 172 can be used to place the apparatus into a sleep state wherein power consumption is conserved until the apparatus is manually switched out of the sleep state via switch 172 to, for example, initiate a call or, as described above, an incoming call automatically does so. Alternately, the apparatus will automatically revert to the sleep state upon termination of a call and time out of detector 112. In an exemplary embodiment, an option can be included whereby incoming calls can still be received when in a sleep state by powering up the apparatus for the duration of the call in response to the detection of the incoming call (or communications signal) via detector 112. Subsequent activation of switch 174 will toggle the FIG. 1 apparatus back into the hearing aid mode, wherein the sleep state can only be activated or deactivated in response to switch 172.

Having provided an overview of the functionality of the FIG. 1 apparatus, aspects of the exemplary FIG. 1 embodiment will now be described in greater detail. The microphone 102, processor 104 and speaker 106 can be configured in known fashion. For example, these components of the hearing aid apparatus 100 can be configured in accordance with hearing aid devices such as those described in the aforementioned U.S. Pat. No. 4,396,806, the contents of which are hereby incorporated by reference in their entirety. Alternately, the processor can be any hearing aid processor, including, but not limited to, those available from GN ReSound, such as the GN ReSound products BTP, BT4 or EDS, the specification sheets of which are hereby incorporated by reference in their entireties. As shown, the exemplary processor 104 includes circuitry for processing the output from a microphone, represented as a preamplifier 114 and automatic gain control feedback block 116 that turns the preamplifier into an automatic gain control (AGC) preamplifier to prevent signal distortion by limiting the outputs of the preamplifier. The output from the AGC preamplifier 114 is directed to a bandsplit filter 118 which supplies the microphone output to multiple channels of the processor 104.

As shown, the output from the bandsplit filter is supplied to a first channel which includes a high band compressor circuit 120, a controllable high pass gain block 122, and an amplifier 124. Another output of the bandsplit filter is supplied via an RC circuit that includes a resistor 126 and a capacitor 128, the resistor being in parallel with a switch 130. This second channel includes a low band compressor 132 and a low pass gain block 134, as well as an output amplifier 136. Outputs from the multiple channels of the processor are summed and supplied via the switch controlled by the detector 112, via a capacitive filter 138 and a driver amplifier 140 to the speaker 106.

The parameters used to control the various channels of the processor 104 can be adjusted and supplied to the processor via a controller 142 of the hearing aid apparatus. This controller can also be configured in a manner similar to the control circuitry described in the aforementioned U.S. Patents, such as U.S. Pat. No. 4,396,806, or in any known fashion. The controller, like the processor can be obtained from GN ReSound in any of a variety of available products including, but not limited to, the GN ReSound BTP, BT4 or ED3. Information used to program the various components of the multiple channels in the processor can be stored in a memory, such as the EEPROM device 144 shown in the exemplary FIG. 1 embodiment.

As shown in FIG. 1, the controller 142 includes a voltage supply, such as a switchable voltage supply V_{cc}, to supply non-detector circuits. In accordance with an exemplary embodiment of the present invention, the controller 142 is coupled to the EEPROM device 144 via a signal path 146 that supplies an Enable Autodetect function. By supplying an enable signal on signal path 146, the apparatus 100 is enabled to permit an automatic switching between the first and second signal paths. Control signals from the controller 144 control the various switches 110, 130 of the FIG. 1 embodiment via signal paths 143 in response to outputs from the detector 112, which are supplied to the EEPROM device 144 via the controller 142 and signal paths 145, 147.

A signal path 148 from the EEPROM 144 to the controller 142 is used to place the hearing aid apparatus in a hearing aid mode or in a communications mode, in response to inputs from the switches 172 and 174 associated with the detector 112. For example, a logic level high on the signal path 148 can be used to place the hearing aid apparatus into a hearing aid mode (designated hearing health care, or HHC, mode), while a logic level low on signal path 148 can place the hearing aid apparatus 100 into a non-HHC, or communication, mode.

The switch 166 can also be used, when switching between the hearing aid state and the communications state, to initiate the download of either a communications program for controlling sound processing in the second path or a hearing aid program for controlling sound processing in the first path. Depending on the state of operation, the appropriate data is transferred from the EEPROM 144 into registers of the controller 142.

The programs stored in the EEPROM can be first and second sets of sound processing control parameters for each of the components in the first and second channels (or any number of channels) of processor 104 for use in the hearing aid state and the communications state, respectively. The information stored in these registers is used to control components of the processor 104. In an exemplary embodiment, the controller 142 is configured as a digital chip, and information stored in the registers is supplied, via digital-to-analog converters, as control currents used by processor 104, which in the exemplary FIG. 1 embodiment, is an analog processor. However, those skilled in the art will appreciate that the controller 142 and the processor 104 can be configured as analog devices, as digital devices, or as any combination of analog or digital devices.

As already mentioned, the components of the exemplary FIG. 1 embodiment can be configured in a manner as described in U.S. Pat. No. 4,396,806 or as disclosed in hearing aid processors available from GNReSound. Alternately, or in addition, these devices can be configured in a manner as described in any one or more of U.S. Pat. No. 4,868,517 entitled “VARIOLOSSER”, U.S. Pat. No. 4,882,761 entitled “LOW VOLTAGE PROGRAMMABLE COMPRESSOR”, U.S. Pat. No. 4,882,762 entitled “MULTI-BAND PROGRAMMABLE COMPRESSION SYSTEM”, U.S. Pat. No. 5,278,912 entitled “MULTI-BAND PROGRAMMABLE COMPRESSION SYSTEM”, and/or U.S. Pat. No. 5,488,668 entitled “MULTI-BAND PROGRAMMABLE COMPRESSION SYSTEM”, the contents of which are hereby incorporated by reference in their entireties.

A more detailed discussion will now be provided of the switch 110 and associated detector 112. As shown in the exemplary FIG. 1 embodiment, the switch 110 includes switch elements 150, 152 and 154. In a hearing aid state, switch 150 is closed and switches 152, 154 are opened. In a communications state, either or both of switches 152, 154 are closed and switch 150 is opened. The switches can, for example, be implemented as transistors controlled in response to outputs from the controller 142 via signal paths 143, based on the detection of predetermined conditions by detector 112.

The program that is downloaded from the EEPROM 144 into the controller 142 for purposes of providing control currents to the various components of the processor 104 can be selected depending on whether a hearing aid state or a communications state is active. When in a hearing aid state, a specific program tailored to address hearing impairments of the user can be used to process audio inputs received via the microphone 102 for output into the user's ear via speaker 106. In contrast, when in a communications state, an audio input received via a microphone 102 need not be processed to address the hearing impairment of the user, because the audio inputs will be sent via the second path to the cell phone or radio 108. As such, when in a communications state, the processor 104 need not be programmed to address the hearing impairment of the user, but could be programmed to improve the quality of the signals received and/or sent over the cell phone or radio 108 to, for example, filter ambient background noise. As such, the sound processing control parameters can be selected based on the desired quality of the transmitted signal.

Signals that are received via the cell phone or radio 108 for output into the ear canal via the speaker 106 can be supplied directly to speaker 106 without further sound processing. However, those skilled in the art will appreciate that, if desired, the output signals from the cell phone or radio can be supplied through sound processing circuitry of the processor 104, programmed in a manner to improve the quality of sound supplied to the ear canal of the user via the speaker 106, or to address a hearing impairment of the user.

In the signal paths between the switch 110 and the cell phone or radio 108, variable gain amplifiers 156 and 158 are provided. The variable gain amplifier 156 is associated with a parallel resistor (e.g., shown as a 2.5 kilo-ohm resistor 160). The output impedance associated with the signal path from the switch 110 to a microphone input of the cell phone or radio 108 is, in the exemplary FIG. 1 embodiment, approximately 100 ohms, with a gain of −10 to 20 dB, the exact gain being programmed by the controller 142 in response to inputs received from the EEPROM 144. Typical microphone input circuit parameters of the cell phone or radio 108 are, in the exemplary FIG. 1 embodiment, in the range of 1 to 100 kilo-ohms, with a 10 millivolt root mean square voltage. The variable gain amplifier 156 allows the hearing aid apparatus 100 to be adjusted to match the input requirements of any of the various communications equipment, as exemplified by cell phone or radio 108.

The speaker output of the cell phone or radio 108 has, in the exemplary FIG. 1 embodiment, an output impedance on the order of 0 to 40 ohms, and provides an output voltage ranging from approximately 100 millivolts to 4 volts root means square. The input impedance to the hearing aid device at the variable gain amplifier 158 is higher, with an exemplary gain of −30 to 10 dB, the exact gain being adjustable in response to a programmable gain set by the EEPROM 144. Again, variable gain amplifier 158 allows the hearing aid apparatus to be matched to, and used with any communications equipment, including but not limited to, cell phone or radio 108.

As already mentioned, a signal from the cell phone or radio 108 can be monitored via a signal path 162 that is supplied to the detector 112 to automatically switch the apparatus 100 into an active communications state via activation of an exemplary switch 164 in detector 112. The signal path can be optionally used to monitor an active speaker output line from the cell phone or radio 108 to maintain the hearing aid apparatus 100 in the communications state. In the exemplary FIG. 1 embodiment, the speaker output line of the cell phone 108 is monitored, and an automatic switch to a communications state is effected when a voltage Vₚ on this line exceeds a threshold voltage Vₜₕ of approximately 10 millivolts at least three times over the course of a 6 millisecond period. Those skilled in the art will appreciate that the exact threshold and the conditions used to automatically detect a signal on the speaker output line of the cell phone 108 can be varied as desired (e.g., exceeding of any desired threshold, any number of times, over any desired period of time) to effectuate the automatic switching. Alternately, or in addition, the detector 112 can be configured to monitor a ring line of the cell phone or radio to activate a communications state.

In the exemplary embodiment shown, where the user has engaged the second signal path to a cell phone, and the user is communicating via the voice signal input of the cell phone, the detector will maintain the hearing aid apparatus in the communications state by, for example, monitoring a sidetone signal on the receive line via signal path 162. Although the exemplary FIG. 1 embodiment only shows the detector 112 as monitoring the speaker output line of the cell phone 108, those skilled in the art will appreciate that conventional cell phones provide some feedback of the user's voice (sidetone) when the user is communicating via a cell phone. Accordingly, even when the user is speaking to the voice signal input of the cell phone 108, a small feedback of the user's voice will be provided over the speaker output line of the cell phone, and can be monitored via signal path 162 to maintain the hearing aid apparatus in a communications state.

However, when no signal is being received from the cell phone or radio 108, and the user is not communicating to the cell phone or radio 108, the detector will sense the absence of activity on the second signal path and return the hearing aid apparatus to the hearing aid state or the sleep state, depending on whether the hearing aid mode or the communications mode has been activated via switches 172 and 174.

In the exemplary FIG. 1 embodiment, the switch 164 in detector 112 changes state (e.g., opens) upon a determination by detector 112 that no signal is available for monitoring via signal path 162 for a predetermined period of time. In the exemplary FIG. 1 embodiment, a 10 second delay is provided before switching the hearing aid apparatus back to the hearing aid state or into the sleep. state. As shown in FIG. 1, when switch 164 toggles (e.g., changes state) and the hearing aid mode has been selected via switch 174, normally closed switch 166 toggles to switch between the hearing aid state and the communications state (provided switch 166 is not held in an open position by selecting the sleep state via switch 172). Toggling of switch 166 causes the controller 142 to change the operating status of switches 150, 152 and 154, and to configure them in a hearing aid state. If the communications mode is selected via switches 172 and 174, automatic switching to the hearing aid state is disabled, and instead the device automatically switches to the sleep state when not actively communicating, to conserve battery power.

In operation, switch 166 constitutes a power switch which is open in a sleep state to power down at least portions of the apparatus 100. In the FIG. 1 example, switch 166 is open when in a sleep state, although the circuit can, of course, be configured such that the sleep state is active when switch 166 is in a closed position. The detector 112 includes two inputs labeled 168 and 170. Input 168 is activated by the manual switch 172 to alternately switch the detector 112 between an on state and a sleep state.

When the communications mode is selected via switches 172 and 174, the apparatus enters the sleep state and remains asleep following activation of the sleep state until a signal is either received via the cell phone/radio 108, or until the user manually activates the apparatus 100 out of the sleep state to, for example, initiate a call. The switch 166 controls the supply of power to the processor 104 via the controller 142. If, for example, an incoming call is detected by detector 112 from the cell phone/radio 108, the detector supplies a signal to the controller 142 (which, in an exemplary embodiment, remains active even in a sleep state). The controller 142 then reactivates the processor 104. Similarly, when the user manually reactivates the apparatus 100 from the sleep state by momentarily depressing switch 172, the controller 142 receives a signal via the detector 112 to power-up processor 104.

If the hearing aid mode is selected via switch 174, the apparatus goes into the hearing aid state where it can then be placed into the sleep state by activation of push button switch 172, or into the communications state by activation of push button switch 174. Thus, switches 172 and 174 provide the user an ability to acquire and use the apparatus in the hearing aid mode as a communications/hearing aid device having a power saving feature, or to use the apparatus exclusively in the communications mode, wherein the device sleeps whenever not actively in communications operation.

In the communications mode, when the detector 112 senses that the hearing aid apparatus 100 is to be placed into the active communications state, either in response to a detected signal on signal path 162 or a manual activation of switch 172, switch 164 and switch 166 close. The closing of switch 166 supplies a V_{cc} input to the EEPROM 144 which results in a program used to drive the processor 104 being supplied to the processor 104 via the controller 142.

In an exemplary communications state, the two channels of the processor 104 are used; that is, one channel that includes the low band compressor 132, low pass gain 134 and amplifier 136, and a second channel that includes high band compressor 120, high pass gain amplifier 132 and amplifier 124. The two channels process sound received by microphone 102 for output via the cell phone 108. The use of both channels permits operation in the typical telecommunications band above 300 Hz. The switch 130, along with the resistor 126 and capacitor 128 form a high pass filter in series with a low band portion of the circuitry in processor 104.

In the hearing aid state, the switch 130 is closed to short the resistor 126 so that the full frequency band is retained and not cut off below 300 Hz. As already mentioned, different parameters, as desired, can be used to program the various components of the two channels during the hearing aid state and communications state, with the exact parameters downloaded from the controller 142 to the processor 104 being selected in response to outputs from the detector 112.

Thus, during a communications state, sound picked up by the microphone can be delivered to the remote location (i.e., the cell phone 108 as shown in FIG. 1) via a portion of the first signal path that includes the sound processing circuitry. This permits a recipient of the sound at a downstream link of the cell phone to receive the sound with, for example, reduced ambient noise. Sound which is supplied from the remote location (e.g., from the cell phone, radio, or any other sound source) passes through the second signal path via the switch 110 to the speaker 106.

In a hearing aid state, the switch 164 toggles switch 166, such that information supplied from the EEPROM 144 to the processor 104 configures the various channels included therein in accordance with the hearing impairment of the user. As such, sound received via the microphone 102 is processed in the various channels, and delivered via switch 150 directly to the speaker 106 associated with the earpiece of the hearing aid apparatus.

It will be appreciated by those of ordinary skill in the art that the present invention can be embodied in other specific forms without departing from the spirit or essential characteristics thereof. The presently disclosed embodiments are therefore considered in all respects to be illustrative, and not restrictive. The scope of the invention is indicated by the appended claims, rather than the foregoing description, and all changes that come within the meaning and range of equivalence thereof are intended to be embraced therein.

What is claimed is:

1. Hearing aid apparatus comprising:
a first signal path having a microphone for receiving sound in a vicinity of a user, a processor for processing the sound into a processed sound, and a speaker for outputting the processed sound into a vicinity of an ear canal of the user;
a second signal path for establishing communication between at least a portion of the first signal path and a location remote from the user; and
a switch for automatically selecting the first signal path or the second signal path in response to detected occurrence of a predetermined condition of the second signal path.

2. Hearing aid apparatus according to claim 1, wherein the first signal path is selected when the hearing aid apparatus is in a hearing aid state.

3. Hearing aid apparatus according to claim 1, wherein the second signal path is selected when the hearing aid apparatus is in a communications state with a remote communications device.

4. Hearing aid apparatus according to claim 1, wherein said predetermined condition is a detected ring condition of a cell phone.

5. Hearing aid apparatus according to claim 1, wherein the predetermined condition is the absence of a detected active signal in the second signal path for a predetermined period of time.

6. Hearing aid apparatus according to claim 1, wherein the second signal path is a two-way communication path with a telephone network.

7. Hearing aid apparatus according to claim 1, comprising:
a switch to manually select between the first signal path and the second signal path.

8. Hearing aid apparatus according to claim 1, comprising:
a switch to place the apparatus into a sleep state, wherein power to at least some components is shutdown.

9. Hearing aid apparatus according to claim 1, comprising:
a memory to store a first set of sound processing control parameters for the first signal path, and for storing a second set of sound processing control parameters, different from the first set, for the second signal path.

10. Hearing aid apparatus according to claim 9, wherein the first set of sound processing control parameters are selected based on a hearing impairment of a user.

11. Hearing aid apparatus according to claim 10, wherein the second set of sound processing control parameters are selected based on the quality of a transmitted signal.

12. Hearing aid apparatus according to claim 9, wherein the second set of sound processing control parameters are selected based on the quality of a transmitted signal.

13. Hearing aid apparatus according to claim 1, comprising:
a switch for manually selecting the first signal path or the second signal path, such that when the second signal path is manually selected, the apparatus is automatically placed into a sleep state in response to the predetermined condition.

14. Hearing aid apparatus according to claim 1, comprising:
a switch for manually placing the apparatus into a sleep state.

15. Hearing aid apparatus according to claim 2, comprising:
a switch for selecting a communications mode wherein the hearing aid state is disabled, and the apparatus can be switched between a communications state and a sleep state.
